(19) United States
(12) Patent Application Publication
(10) Pub. No.: US 2007/0133506 A1
(43) Pub. Date: Jun. 14, 2007

(54) Data transmitting system and the method of the same

(75) Inventors: Shao-Ming Wu, Taipei (TW); Chen-Chun Lai, Taipei (TW)

Correspondence Address: BIRCH STEWART KOLASCH & BIRCH, PO BOX 747, FALLS CHURCH, VA, 22040-0747, US

(73) Assignee: Daka Studio Inc.

(21) Appl. No.: 11/296,813

(22) Filed: Dec. 8, 2005

(51) Int. Cl. H04L 12/66

(52) U.S. Cl. 370/352

(57) ABSTRACT

The present invention discloses a data transmitting system and method. The system is used for connecting an electronic device to a remote server through a computer and a network. The electronic device excludes an earphone. The data of the electronic device transmits to a computer through an audio line, and then transmits to the server through a network. The server can also transmit a data to the electronic device through the audio line after receiving from the electronic device.

### BACKGROUND OF THE INVENTION

1. Field of the Invention

The present invention relates to a system and a method for transmitting data of an electronics device to a web server, especially by connecting through audio line.

2. Description of the Prior Art

There are many ways to transmit data from an electronic device to a remote computer by the Internet. The electronic devices are usually very small, and contain some data. Generally, the device should connect to a computer while the computer connects to the remote web server through the Internet, and the server may receive data of the electronic device through the computer.

The computer connects to the peripheral devices through various connecting ports. For example, the keyboard connects to the computer through a keyboard port, mouse connects to the computer through serial port (COM1 and COM 2) or PS/1, PS/2 port, a printer connects through a EPP/ECP parallel port, a display connects through a DVI output port, and RJ-45 connector connects to a modern.

The USB ports are the most frequently used port for several other devices to connect to computer. For example, the memory disk, digital camera and video camera, and card reader. The computer can transmit or receive data or message from the devices through the USB port.

Although the USB port can be used for connection, the cost of the USB ports is too expensive for some small electronic devices. Besides, the cost of the USB port is also not allowed for low cost electronic devices.

In view of the aforementioned, the present invention provides a new system and method for a low cost electronic devices to connect to a web server.

### SUMMARY OF THE INVENTION

To achieve the foregoing and other objects and according to the purpose of the present invention, a system for an electronic device connect to a web server through the Internet by a computer.

Another purpose of this invention is to provide one method for an electronic device to connect to a web server and transmit data to the web server through an audio in port of the computer.

One more purpose of this invention is to provide a data transferring method for an electronic device to transferring data to a web server through an audio in port across the Internet.

This invention discloses a data-transmitting system, comprising: an electronic device with an output port and a circuit for transforming digital data to analog data, wherein the electronic device excludes an ear phone of microphone; a computer with an audio in port connected to the output port of the electronic device; and a web server connected to the computer through a network.

The present invention also provides a data-transferring system, comprising: an electronic device with an audio jack output port, an audio in port and a circuit for transforming a digital data to a analog data; a computer with an audio in port connecting to the audio output port of the electronic device, and an audio output port connecting to the input port of the electronic device; and a web server connected to the computer through a network.

This invention also discloses a method for transmitting data from an electronic device to a web server, comprising: connecting an output port of an electronic device to an audio in jack of a computer, and an input port of the electronic device to an audio out jack of the computer; connecting the computer to a web server through an network; executing a receiving and transmitting program; the server receiving a data of the electronic device through the audio in jack port; and the server transmitting a response data to the electronic device through the audio out jack.

The present invention further discloses a method for transmitting data from an electronic device excepting an ear phone to a web server, comprising: connecting an output port of the electronic device to an audio in jack of a computer, wherein the electronic device has data contain therein; connecting the computer to the web server through a network; executing an audio-port data receiving and transmitting program; and receiving the data by the server.

### BRIEF DESCRIPTION OF THE DRAWINGS

Some of the purposes and advantages of the invention have been fully stated, others will be more fully understood by reference to the accompanying drawings, in which:

FIG. 1 is a schematic diagram of a data transferring system of the present invention.

FIG. 2 is a flow diagram of a method for transferring data to a web server from an electronics device of the present invention.

FIG. 3 is a schematic diagram of a data transferring system of the present invention.

FIG. 4 is a flow diagram of a method for transferring data to a web server from an electronics device of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. Then, the components of the different elements are not shown to scale. Some dimensions of the related components are exaggerated and meaningless portions are not drawn to provide clearer description and comprehension of the present invention.

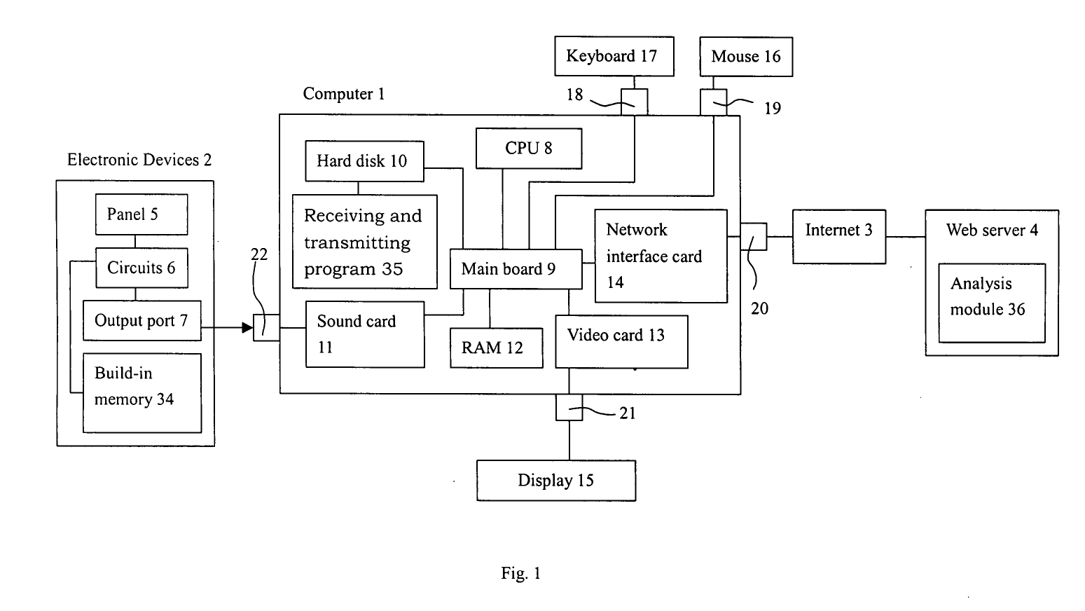

Referring to FIG. 1, which is a schematic diagram of a data transferring system of the present invention. The data transmitting system of the present invention comprises: a computer 1, an electronics device 2, the Internet 3 and a web server 4. The electronic device 2 includes a housing having a panel 5 formed thereon and circuits 6, output port 7 contain therein. The computer 1 comprises a CPU 8, a main board 9, a hard disk 10, sound card 11, RAM 12, a video card 13, a network interface card 14, a keyboard 17, a keyboard port 18, a mouse 16, a mouse port 19, a audio in port 22, a display 15, a video card 13, a video port 21 and a network port 20 as known in the art.

During the operation, the electronics device 2 could be connected to the computer 1 through an audio in port (phone jack port) 22 of the sound card 11. It should be noted that no one uses the phone jack port to transmit non-audio signal to remote terminal. It is one of aspects of the present invention. The computer 1 is coupled to the web server 4 through the Internet 3. The keyboard 17 connects to the computer 1 through keyboard port 18, which is a serial port or a PS/2 port. The mouse 16 connects to the computer 1 through the mouse port 19 which may be a COM 1 or USB port. The display 15 is typically connected to the computer 1 through DVI or S-video port. The audio in port is generally connected by a microphone for recording sound (audio) data. The OS such as Windows usually includes a standard recording program.

The electronic device 2 is a simple electronic device including a panel 5, circuit 6 and the output port 7. The electronic device 2 contains some data, such as a set or number in built-in memory 34, the data can be shown on the panel 5. The circuit 6 is used for controlling the panel 5 and outputting the data to the output port 7. The output port 7 can be of the same type of the audio in port 22, and the output port 7 and the audio in port 22 can be connected by an audio line. The output port 7 may be a connector, which can connect to the port 22 directly. The audio in port transports analog type data, therefore the circuit 6 of the electronic device 2 is capable of transforming the digital data of the electronic device 2 to analog data which can be received by the computer 1. It should be noted that the electronic device 2 excludes the conventional ear phone or microphone that may only receives or transmit analog signal only. The electronic device includes electronic steps counter, blood pressure meter, pulse meter, electronic portable game device or electronic portable toy.

The computer 1 receives the data from the electronic device 2 by an audio-port data receiving and transmitting program 35. The receiving and transmitting program 35 may further have analysis function for the data. The data is composed of identifying code of the data signal for identifying the electronic device 2; therefore the data can be transported to original data of the device 2. The receiving and transmitting program 35 then transmits the data to a web server 4 through a network such as an Internet 3. The audio-port data receiving and transmitting program can be provided by the device manufacturer, or can be downloaded by the user in the web server 4.

In one embodiment of the present invention, the receiving and transmitting program is executed from the web server 4. The user may connect the computer to the web server 4 by connecting a web site or homepage of the server 4, and click a bottom to activate the receiving and transmitting function. The data of the electronics device 2 is received and transmitted from the server 4 directly, and the computer 1 does not need any program but only a web explorer. The technology for a remote server 4 connecting to a specific port of a local computer is already used widely in many applications, such as network meeting. The data is then analysis in the web server. The web server 4 may store or rank these data transmitted by different users from different place. Thus, the remote server includes the analysis module 36 contain therein.

In an embodiment of the present invention, the electronic device 2 is, for instance, a steps-counter, which is small in the size therefore is conveniently carried by user. The counter includes a panel showing the number of user's steps, circuit for controlling the counter and an output port. The counter can connect to a computer through the output port by an audio line. And the user connects to a specific web server and uploads the steps data of the counter. The user connects to a web server of the steps counter provider by logging in a homepage or web site, and transmit the step data to the web server. The provider can hold a competition by ranking different steps data from different users, which can be used for business purpose or entertainments.

In another embodiment of the present invention, the device is a blood pressure meter for measuring user's blood pressure. The blood pressure data can be record for medical use or tracking by a hospital server.

Besides, in one embodiment of the present invention, the electronic device can be an electronic toy for children or an electronic instrument. The score can be stored in the toy and transmitted to a web server for ranking or other application. The cost of the toy can be decreased with the present connection system.

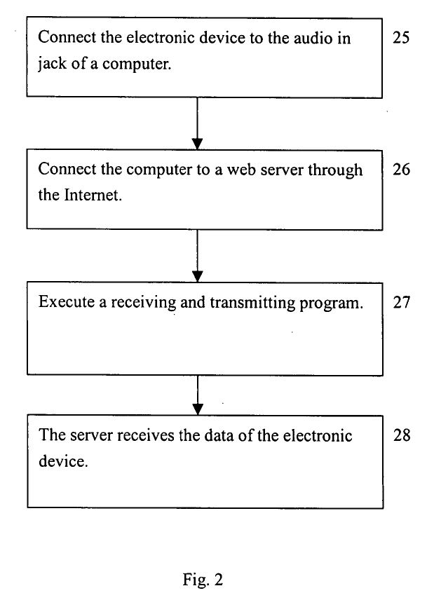

FIG. 2 is a flow schematic shows a method for data transferring to a web server through an audio in port of the present invention. The method including: the block 25, connect the electronic device to the audio in jack of a computer through audio line; the block 26, the computer connects to a web server through the internet; the block 27, the server connects to the computer and receives the data of the electronic device through the audio in jack of the computer; and the block 28, the server registers the data for further application.

In the block 25, the electronic device may connect to the audio in jack port of a computer directly if the output port of the device is a connector. In the block 26, the computer connects to a web site or homepage in a remote web server through the Internet. In the block 27, a receiving and transmitting program is executed for receiving the data from the electronic device and transmitted to the server. The program may be executed in the server, and the server can receive a signal or data generated by the device through the audio line. In the block 28, the server receives the data from the electronic device.

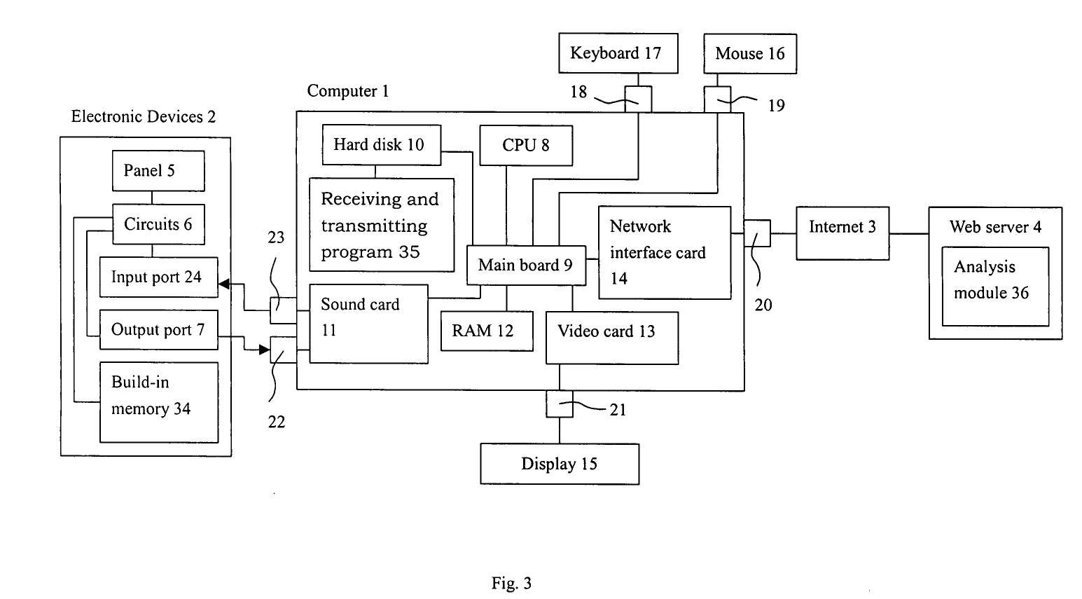

Referring to FIG. 3 shows another embodiment of a data transmitting system of the present invention. The electronic device 2 includes an input port 24 and an output port 7 connecting to the circuit 6. Wherein the input port 24 and the output port 7 are of the same type. And the input port 24 is used for connecting to an audio out port 23 of the computer 1 through an audio line.

The web server 4 receives the data from the electronic device 2, and can send a data to the electronic device 2. In one embodiment of the present invention, the electronic device is a step counter. After transmitting the step data to the web server, the server sends a reset signal to the step counter to reset the counter.

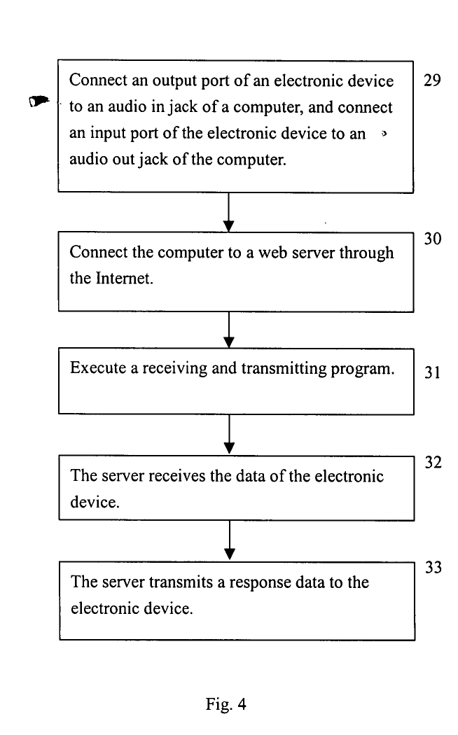

Referring to FIG. 4, which shows a method for transmitting a data of an electronic device to a web server of the present invention. The method includes: the block 29, connecting an output port of an electronic device to an audio in port of a computer, and connecting an input port of the electronic device to an audio out port of the computer; the block 30, connecting the computer to a web server through the Internet; the block 31, executing a receiving and transmitting program; the block 32, the server receiving the data of the electronic device; and the block 33, the service transmits a response data to the electronic device.

In the block 29, the input port and the output port of the electronic device connects to the audio out port and the audio in port of the computer separately with audio line. After the server receiving the data from the electronic device as in the block 32, the server transmits a response data to the electronic device through the input port. In one embodiment of the present invention, the response data includes a reset signal for the step counter.

Therefore, the present invention provides a data transmitting method for an electronic device to transmitting data to a remote web server through an audio in port of the computer. The electronic device connects the audio in and audio out port of the computer, and can transmit and receive from the web server. A receiving program may be executed on the server or downloaded by the user. The program can receive and transmit a signal or data from the electronic through the audio in port.

According to another view, the present invention provides a method for transmitting data from an electronic device to a web server through the audio in port. The cost of the device can be decreased according to the present invention.

Although specific embodiments have been illustrated and described, it will be obvious to those skilled in the art that various modifications may be made without departing from what is intended to be limited solely by the appended claims.

1. A data-transmitting system, comprising:
an electronic device with an output port and a circuit for transforming digital data to analog data, wherein said electronic device excludes an ear phone;
a computer with an audio in port connected to said output port of said electronic device; and
a web server connected to said computer through a network.

2. The system in claim 1, wherein said electronic device further comprising a panel for displaying a digital data and an output port.

3. The system in claim 1, wherein said analog data including identifying data and numbers.

4. The system in claim 1, wherein said electronic device includes electronic steps counter, blood pressure meter, pulse meter, electronic portable game device or electronic portable toy.

5. The system in claim 1, wherein said computer comprises an audio-port data receiving and transmitting program through an audio in port of said computer.

6. The system in claim 1, wherein said server including a web site or homepage and an analysis module, said computer can connect to said server by logging in said homepage and execute said program.

7. A data-transferring system, comprising:
an electronic device with an audio jack output port, an audio in port and a circuit for transforming a digital data to a analog data;
a computer with an audio in port connecting to said audio output port of said electronic device, and an audio output port connecting to said input port of said electronic device; and
a web server connected to said computer through a network.

8. The system in claim 7, wherein said electronic device further comprising a panel for displaying a digital data and an output port.

9. The system in claim 7, wherein said analog data includes identifying data and numbers.

10. The system in claim 7, wherein said electronic device includes electronic steps counter, blood pressure meter, pulse meter, electronic portable game device or electronic portable toy.

11. The system in claim 7, wherein said computer comprises an audio-port data receiving and transmitting program through an audio in port of said computer.

12. The system in claim 7, wherein said server including a web site or homepage and an analysis module, said computer can connect to said server by logging in said homepage and execute said program.

13. A method for transmitting data from an electronic device to a web server, comprising:
connecting an output port of an electronic device to an audio in jack of a computer, and an input port of the electronic device to an audio out jack of the computer;
connecting the computer to a web server through an network;
executing a receiving and transmitting program;
said server receiving a data of said electronic device through said audio in jack port; and
said server transmitting a response data to said electronic device through said audio out jack.

14. The method in claim 13, wherein said data including identifying data and numbers.

15. The method in claim 13, wherein said electronic device includes electronic steps counter, blood pressure meter, pulse meter, electronic portable game device or electronic portable toy.

16. The method in claim 13, wherein said computer comprises an audio-port data receiving and transmitting program through an audio in port of said computer.

17. A method for transmitting data from an electronic device excepting an microphone to a web server, comprising:
connecting an output port of said electronic device to an audio in jack of a computer, wherein said electronic device has data contain therein;
connecting said computer to said web server through a network;
executing an audio-port data receiving and transmitting program; and
receiving said data by said server.

18. The method in claim 17, wherein said data includes identifying data and numbers.

19. The method in claim 17, wherein said electronic device includes electronic steps counter, blood pressure meter, pulse meter, electronic portable game device or electronic portable toy.

20. The system in claim 17, wherein said computer comprises an audio-port data receiving and transmitting program through an audio in port of said computer.
